(19) United States
(12) Patent Application Publication
(10) Pub. No.: US 2001/0017661 A1
(43) Pub. Date: Aug. 30, 2001

(54) Digital camera

(75) Inventor: Tetsuji Shono, Saitama (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/790,602

(22) Filed: Feb. 23, 2001

(30) Foreign Application Priority Data
Feb. 25, 2000 (JP) P2000-048487

(51) Int. Cl. H04N 5/222

(52) U.S. Cl. 348/341; 348/333.01; 348/335

(57) ABSTRACT

A display member 31 is placed in a position which, as seen from an eyepiece optical system 25, is optically equivalent to the focal plane of an objective optical system 21 and a reflector mirror 33 capable of movement between an electronic image observing position B where the rays of image-bearing light from the display member 31 are reflected toward the eyepiece optical system 25 and an optical picture observing position A where the reflector mirror 33 gets clear of the optical path between the focal plane of the objective optical system 21 and the eyepiece optical system 25 is placed between the focal plane of the objective optical system 21 and the eyepiece optical system 25.

### BACKGROUND OF THE INVENTION

This invention relates to a digital camera, particularly to a viewfinder and a display panel that are used in it.

Digital cameras usually have a LCD panel on the rear outer side of the camera body. The picture taken with a CCD (imaging device) is processed to produce an electronic image which is then displayed on the LCD panel. The user observes the displayed image by direct viewing of the LCD panel. The LCD panel is illuminated with a rearward light, commonly called a backlight, so that the user can observe the image as it passes through the panel. Since the electronic image displayed on the LCD panel has the same field of view as the taken (recorded) picture, there is no problem of parallax which has been considered inevitable to cameras having the imaging optics displaced from the viewfinder optics.

A problem with the backlighted LCD panel is that it is not clearly visible outdoors where bright light is abundant. As another problem, the LCD panel is of such a big size that the backlight consumes significant power. In addition, the LCD panel has an inherently narrow range of viewing angles and its visibility is low if it is seen at an angle rather than normal to the screen.

### SUMMARY OF THE INVENTION

An object, therefore, of the present invention is to provide a digital camera having the viewing optics displaced from the viewfinder optics and which allows either the electronic image or the optical picture to be observed through a finder window by means of a switching mechanism.

This object of the invention can be attained by a digital camera having viewfinder optics displaced from imaging optics and a display member for providing an illuminated display of an electronic image taken with an imaging device located in the focal plane of the imaging optics, the viewfinder optics comprising an objective optical system, an erecting optical system for inverting and reversing right and left an object image formed with the objective optical system, and an eyepiece optical system for observing the image reverted and inverted with the erecting optical system, characterized in that the display member is placed in a position which, as seen from the eyepiece optical system, is optically equivalent to the focal plane of the objective optical system and that a reflector mirror capable of movement between an electronic image observing position where the rays of image-bearing light from the display member are reflected toward the eyepiece optical system and an optical picture observing position where said reflector mirror gets clear of the optical path between the focal plane of the objective optical system and the eyepiece optical system is placed between the focal plane of the objective optical system and the eyepiece optical system.

Preferably, a control means for turning on and off the illuminated display by the display means is provided to turn on the display means when the reflector mirror is in the electronic image observing position and turn it off when the reflector mirror is in the optical picture observing position. During observation of the optical picture, the display means is not necessary and turned off to save on power consumption.

The present disclosure relates to the subject matter contained in Japanese patent application No. 2000-48487 (filed on Feb. 24, 2000), which is expressly incorporated herein by reference in its entirety.

### BRIEF DESCRIPTION OF THE DRAWINGS

FIG. 1 is a section of the digital camera of the invention as seen from the side;

FIG. 2 is a schematic for the viewfinder optics;

FIG. 3 is a perspective view of the two prisms in the erecting optical system;

FIG. 4 is a block diagram of the control system;

FIG. 5 is a perspective view of another embodiment of the erecting optical system; and

FIG. 6 is a side view of FIG. 5 as seen in the direction indicated by arrow X.

### DESCRIPTION OF THE PREFERRED EMBODIMENT

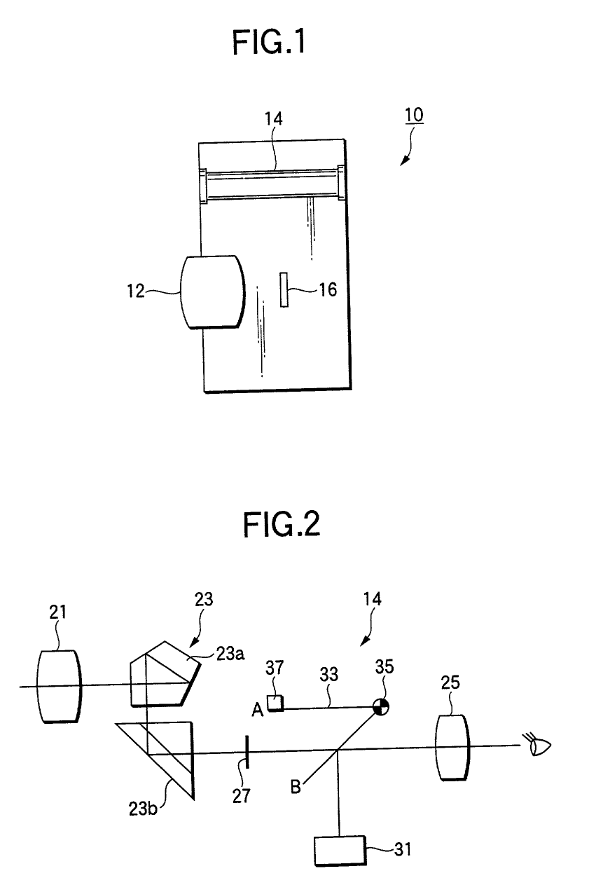

A preferred embodiment of the invention is described below. FIG. 1 is a section of a digital camera 10 incorporating the concept of the invention. The digital camera 10 has a taking lens (imaging optics) 12 and viewfinder optics 14 in displaced positions. A CCD (imaging device) 16 is placed in the focal plane of the taking lens 12.

As shown in FIG. 2, the viewfinder optics 14 comprise an objective lens (objective optical system) 21, an erecting optical system 23 and an eyepiece lens (eyepiece optical system) 25. The image of the object carried by the beams of light from the objective lens 21 is inverted and reversed right and left by the erecting optical system 23 and focused in the image plane (focal plane) 27. The aerial image (correct real image) focused in the image plane 27 is enlarged and viewed through the eyepiece lens 25.

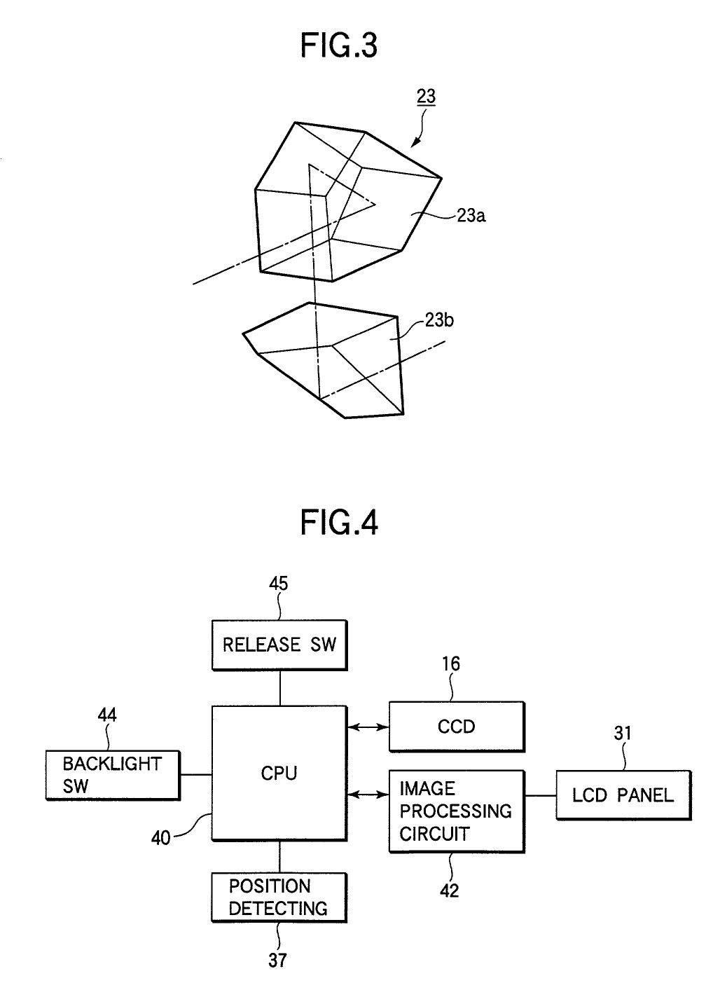

As shown in FIG. 3, the erecting optical system 23 consists of two prisms, a pentaprism 23a having two reflecting faces and a roof prism 23b having two reflecting faces on opposite sides of the roof edge; these two prisms work together to re-invert and reverse right and left the inverted image formed by the objective lens 21.

As shown in FIG. 2, a transmission LCD panel (display member) 31 illuminated with a backlight and a pivotal shaft 35 on which a reflector mirror 33 is supported are positioned on opposite sides of the optical path. The reflector mirror 33 has one of its ends supported pivotally on the pivotal shaft 35 and can move between an optical picture observing position A where the reflector mirror gets clear of the optical path between the image plane 27 and the eyepiece lens 25 and an electronic image observing position B where the beams of image-bearing light from the LCD panel 31 are reflected toward the eyepiece optical system. A position detecting switch 37 is on top of the reflector mirror 33 and turned on when it is in the optical picture observing position A and turned off when it is in the electronic image observing position B.

The LCD panel 31 displays not only the electronic image that was taken with the CCD 16 and subsequently processed for display but also the taken electronic image stored in a memory means. When the reflector mirror 33 is in the electronic image observing position B, the LCD panel 31 is in an position which, when seen from the eyepiece lens 25, is optically equivalent to the image plane 27 and the displayed image is enlarged and viewed through the eyepiece lens 25. The LCD panel 31 is positioned near the viewfinder optics 14 (i.e., within the camera) and the displayed image is enlarged and viewed through the eyepiece lens 25. Hence, the LCD panel 31 is much smaller than the conventional LCD panel which is positioned outside the camera.

FIG. 4 is a block diagram showing the circuit configuration of the control system for the digital camera 10. The overall operation of the camera is controlled by a CPU 40 (control means) to which are connected a CCD 16 and an image processing circuit 42 that processes the image taken with the CCD 16. A group of switches are also connected to the CPU 40 and they are the position detecting switch 37 which checks if the reflector mirror 33 is in the optical picture observing position A, a backlight switch 44 for turning on and off the switch for the backlight of the LCD panel 31, and a release switch 45 for effecting shutter release. Upon receiving input information such as the turning-on and off of the switches connected to it, the CPU 40 executes specified processing steps on the basis of a control program. The backlight switch 44 is turned on and off by the CPU 40 on the basis of the turning-on and off the position detecting switch 37.

The digital camera according to the embodiment under consideration is operated in the following manner. When the reflector mirror 33 is in the optical picture observing position A, the optical path between the image plane 27 and the eyepiece lens 25 is opened and the image from the objective lens 21 that has been focused in the image plane 27 can be enlarged and viewed through the eyepiece lens 25. Thus, the digital camera in this state is used as an optical viewfinder. When the reflector mirror 33 is in the electronic image observing position B, the beams of electronic image-bearing light emerging from the LCD panel 31 are reflected by the reflector mirror 33 and the displayed image is enlarged and viewed through the eyepiece lens 25. In this instance, the image-bearing light from the objective lens 21 is blocked by the reflector mirror 33.

When the reflector mirror 33 moves to the optical picture observing position A, the position detecting switch 37 turns on and the CPU 40 causes the backlight switch 44 to turn off so the supply of electric current to the backlight is cut off and the backlight goes off. When the reflector mirror 33 moves from the optical picture observing position A to the electronic image observing position B, the position detecting switch 37 turns off and the CPU 40 causes the backlight switch 44 to turn on and the backlight comes on. In short, the backlight comes on if it is necessary to observe the electronic image on the LCD panel 31 but it goes off during observation of the optical picture from the objective lens 21 when it is not necessary. Since the backlight is off during the mode of optical picture observation which does not require image display by the LCD panel 31, battery power saving can be accomplished.

A method of moving the reflector mirror 33 between the optical picture observing position A and the electronic image observing position B is by turning a control knob that is attached to the outside of the camera body to be coupled to the pivotal shaft 35. Alternatively, a power drive means may be provided.

As will be clear from the foregoing description, the digital camera 10 in the embodiment under consideration enables the display of an electronic image on the LCD panel 31 to be viewed through the eyepiece lens 25 in the viewfinder optics 14. In other words, with the digital camera 10 the viewing of an optical picture can be changed to the viewing of an electronic image and vice versa by a switching mechanism. In particular, since the electronic image displayed on the LCD panel 31 is viewed through the eyepiece lens 25, high visibility is maintained irrespective of the brightness of the ambient light. What is more, image viewing is always at right angles to the screen of the LCD panel 31 and, hence, is free from the problem of visibility drop due to oblique viewing. Since the image displayed on the LCD panel 31 is enlarged and viewed through the eyepiece lens 25, the LCD panel itself and, hence, the backlight to illuminate it can also be made smaller to reduce power consumption.

The eyepiece lens 25 can be adjusted in eyesight by moving it back and forth along the optical axis.

Since the electronic image displayed on the LCD panel 31 has the same field of view as the taken (recorded) image, the user can observe images without parallax.

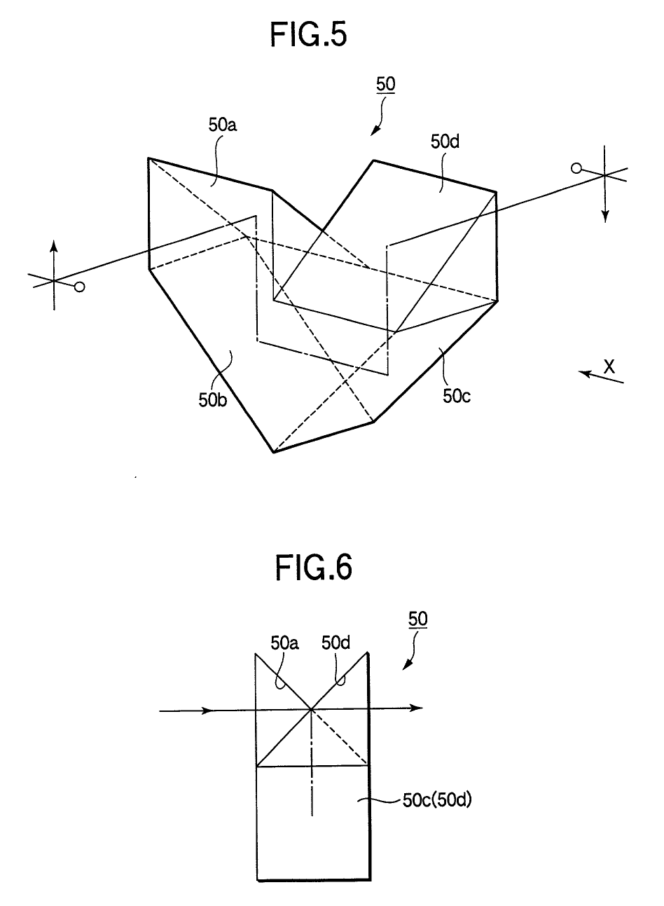

FIGS. 5 and 6 show another embodiment of the erecting optical system 23, in which it is composed of a Porro prism 50. As shown, the Porro prism 50 has four reflecting faces 50a-50d which work together to re-invert and reverse right and left the inverted image from the objective lens 21.

Whichever its type, the erecting optical system may be positioned other than in the optical path between the objective lens 21 and the image plane 27. For example, it may be positioned in the optical path between the image plane 27 and the reflector mirror 33 or in the optical path between the reflector mirror 33 and the eyepiece lens 25.

In the foregoing embodiments, the display member is a transmission LCD panel having a backlight in the rear position. This may be replaced by a reflection LCD panel having a separate illuminating device. Alternatively, a display member having a self-luminescent device may be substituted.

With the digital camera of the invention which has imaging optics displaced from viewfinder optics, both an electronic image and an optical picture can be seen through a finder window, with the viewing of the electronic image being changed to that of the optical picture and vice versa by means of a switching mechanism. This digital camera enables viewing of the electronic image without parallax.

What is claimed is:

1. In a digital camera having viewfinder optics displaced from imaging optics and a display member for providing an illuminated display of an electronic image taken with an imaging device located in the focal plane of said imaging optics, said viewfinder optics comprising an objective optical system, an erecting optical system for inverting and reversing right and left an object image formed with the objective optical system, and an eyepiece optical system for observing the image reverted and inverted with the erecting optical system, the improvement wherein said display member is placed in a position which, as seen from said eyepiece optical system, is optically equivalent to the focal plane of said objective optical system, and a reflector mirror capable of movement between an electronic image observing position where the rays of image-bearing light from said display member are reflected toward the eyepiece optical system and an optical picture observing position where said reflector mirror gets clear of the optical path between the focal plane of said objective optical system and the eyepiece optical system is placed between the focal plane of said objective optical system and said eyepiece optical system.

2. The digital camera according to claim 1, wherein a control system for turning on and off the illuminated display by said display means is provided to turn on said display means when said reflector mirror is in the electronic image observing position and turn it off when said reflector mirror is in the optical picture observing position.

3. A digital camera having a CCD imaging system, the digital camera comprising:
a camera body;
a viewfinder system which obtains an image of an object separately from the CCD imaging system to guide the image to an eyepiece lens provided to the camera body;
a display located within the camera body and connected to the CCD imaging system to display an image of the object obtained by the CCD imaging system; and
a movable mirror which selectively guides one of the image of the object obtained by the viewfinder system and the image of the object displayed on the display to the eyepiece lens.

4. The digital camera according to claim 3, wherein the mirror is pivotably movable between a first position where the mirror prevents the image of the object obtained by the viewfinder system from reaching the eyepiece lens while reflecting the image of the objected displayed on the display to reach the eyepiece lens, and a second position where the mirror does not reflect the image of the object displayed on the display to reach the eyepiece lens while permitting the image of the object obtained by the viewfinder system to reach the eyepiece lens.

5. The digital camera according to claim 4, wherein the display is turned off when the mirror is located at the second position.

6. The digital camera according to claim 4, wherein a backlight of the display is turned off when the mirror is located at the second position.

7. The digital camera according to claim 4, wherein the eyepiece lens is movable in an optical axis direction.

8. The digital camera according to claim 4, wherein the viewfinder system includes an objective optical system defining an image plane, and the image plane and the display are located at optically conjugated positions with respect to the eyepiece lens.
